(19) United States
(12) Patent Application Publication
(10) Pub. No.: US 2010/0036358 A1
(43) Pub. Date: Feb. 11, 2010

(54) Multi-dose container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 12/228,059

(22) Filed: Aug. 7, 2008

(51) Int. Cl. A61J 1/14

(52) U.S. Cl. 604/415

(57) ABSTRACT

A small multi-dose container that has multiple individual sealed chambers is disclosed. Each chamber contains a substance to be extracted and applied with an applicator. An applicator with an elongated hollow handle with approximately the same outside dimension as the inside dimension of the individual chambers is used to extract and apply the substance in the individual chambers. At one end of the applicator is an applicator tip generally in the form of a small spatula or spoon. When the applicator is inserted into one of the sealed chambers, the substance enclosed in the sealed chamber is forced out through the elongated hollow handle of the applicator into the applicator tip to be applied to desired surface.

### BACKGROUND

1. Field of Invention

The present invention relates generally to a small container. More specifically, the present invention relates to a small container with multiple individually sealed chambers containing a unit-dose of substance with a separate applicator for retrieving and applying the substance.

2. Description of Related Art

Small containers are used to distribute small quantities of products such as creams, lotions, and make-ups. The amount of the product in the small container is generally for more than a single application. Once the small container is opened, the container's contents are exposed to the environment and subject to contamination. The subsequent reuse of the opened container subjects the products to further cross-contamination and oxidation.

Furthermore, certain substances must be completely sealed from contact with moisture and/or air until just prior to application. This will require that the contents of the container be single dose and not reused at a later time. Conventional containers are too large for single dose usage and once opened, subject the product to oxidation and contamination.

### BRIEF SUMMARY OF THE INVENTION

The present invention is a small multi-dose container that has multiple individual sealed chambers. Each chamber contains a substance to be extracted and applied with an applicator. In the preferred embodiment, the container has multiple elongated individual chambers enclosing a substance and sealed with aluminum foil or similar covering. An applicator with an elongated hollow handle with approximately the same outside dimension as the inside dimension of the individual chambers is used to extract and apply the substance in the individual chambers. At one end of the applicator is an applicator tip generally in the form of a small spatula or spoon. When the applicator is inserted into one of the sealed chambers, the substance enclosed in the sealed chamber is forced out through the elongated hollow handle of the applicator into the applicator tip to be applied to desired surface.

The small multi-dose container may be further enclosed within another decorative or protective outer container. In this embodiment, the small multi-dose container may be replaced after it is depleted while still retaining the outer container.

### BRIEF DESCRIPTION OF THE DRAWINGS

FIG. 1 shows a perspective view of the preferred embodiment of the multi-dose container in a decorative outer container.

FIG. 2 shows the top view of the preferred embodiment of the multi-dose container.

FIG. 3 shows a side view of the preferred embodiment of the multi-dose container.

FIG. 4 shows a side view of the preferred embodiment of the applicator.

FIG. 5 shows a side view of another embodiment of the multi-dose container with one container on top of another container.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

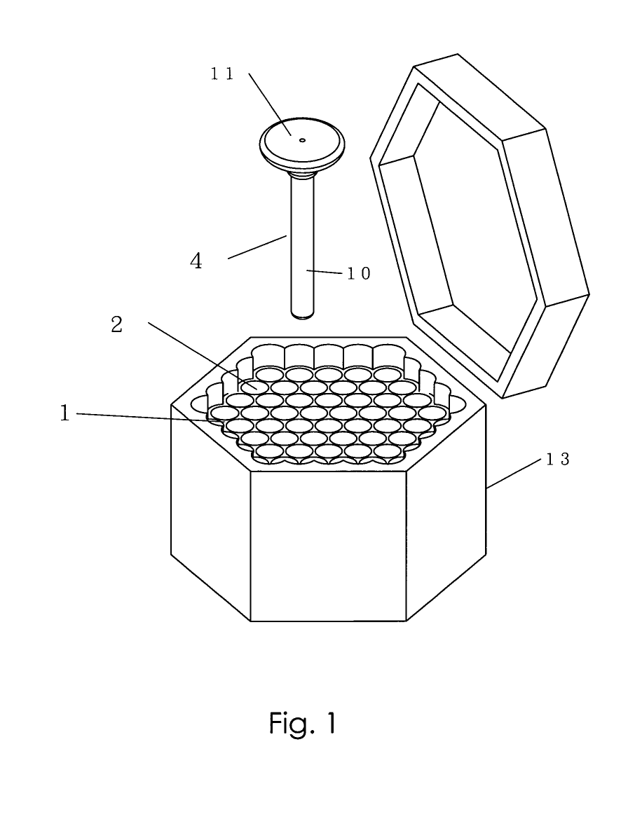

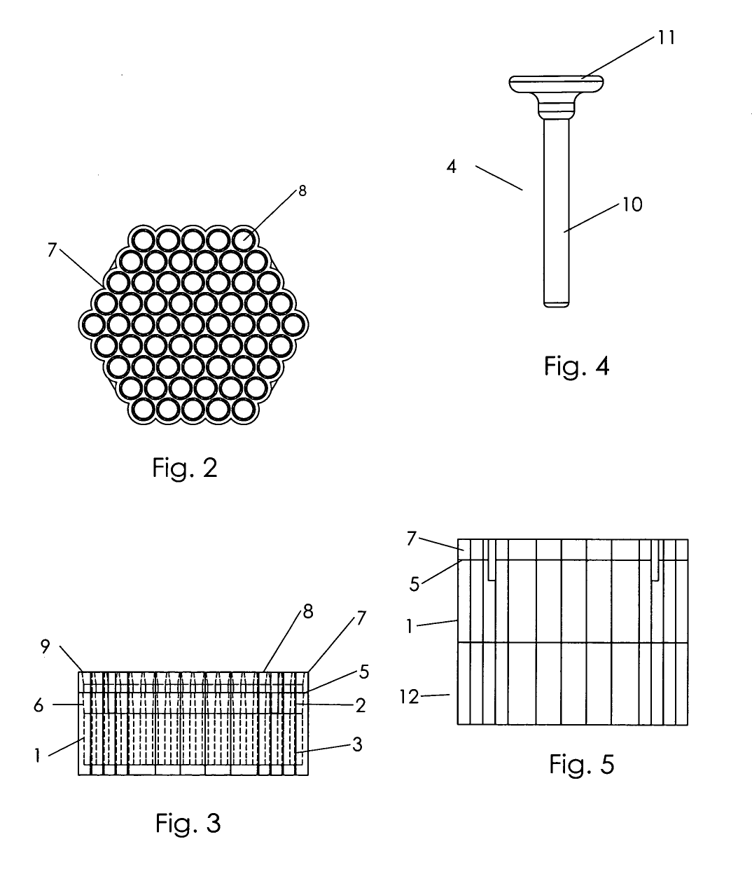

The present invention is a small multi-dose container 1 that has multiple individual sealed chambers 2. In the preferred embodiment, shown in FIGS. 1, 2, 3, and 4, the multiple sealed chambers 2 form a generally hexagonal shape. Each chamber 2 contains a substance 3 to be extracted and applied with an applicator 4. In the preferred embodiment, the container 1 has multiple elongated individual chambers 2 enclosing a substance 3 and sealed with aluminum foil, plastic film, or similar covering 5. Each individual chamber 2 is further provided with a chamfer entrance 6 into the chamber 2 to provide a recess for the fractured seal 5 when it is fractured and folded into the chamber 2 by the inserted applicator 4. The elongated chambers 2 are preferably cylindrical in shape. However, other cross-sectional shapes such as triangle, square, pentagon, or hexagon may also be used. In the preferred embodiment, the covering 5 is provided with preformed or pre-cut lines wherein when pressure is applied to the covering 5 the covering 5 will fracture and break open at the preformed or pre-cut lines.

A guide plate 7 with corresponding openings 8 to the sealed chambers 2 in the multi-dose container 1 is optionally positioned on top of the multi-dose container 1. Each of the openings 8 on the guide plate 7 is provided with a chamfer 9 to guide the applicator 4 and allow easy visual and tactile confirmation of the accurate insertion of the applicator 4 into each individual chamber 2.

An applicator 4, as shown in FIG. 4, with an elongated hollow handle 10 with approximately the same outside dimension as the inside dimension of the individual chambers 2 is used to extract and apply the substance 3 in the individual chambers 2. At one end of the applicator 4 is an applicator tip 11 generally in the form of a small spatula or spoon. Other applicator tips such as a foam tip or a cotton tip may also be used. When the applicator 4 is inserted into one of the sealed chambers 2, the substance 3 enclosed in the sealed chamber 2 is forced out through the elongated hollow handle 10 of the applicator 4 into the applicator tip 11 to be applied to desired surface.

FIG. 5 shows another embodiment of the multi-dose container. In this embodiment, a first container 1 has multiple individual sealed chambers 2 that are sealed on both the top and bottom of the chambers 2 with a fracturable covering. Each chamber 2 contains a substance 3 to be extracted and applied with an applicator 4. A second container 12 with corresponding multiple individual chambers are positioned immediately under the first container 1. Each chamber in the second container 12 may be empty or may contain a second substance. The individual chambers in the second container 12 may also be sealed with a fracturable covering.

In this embodiment, when the applicator 4 is inserted through a chamber 2 in the first container 1, the enclosed substance 3 will be forced through the hollow handle 10 of the applicator 4 into the applicator tip 11 for application. Upon further insertion of the applicator 4 into the chamber in the second container 12, the air or the second substance in the chamber will be forced into the hollow handle 10 of the applicator 4. If the chamber in the second container 12 is empty, the air in the chamber will force most of the substance 3 from the first container 1 out of the hollow handle 10 into the applicator tip 11 thereby more fully extract the substance 3. If the chamber in the second container 12 contains a second substance, the second substance may be extracted along with the first substance 3 to be applied either in sequence or in combination, depending on the depth of insertion of the applicator 4.

The small multi-dose container 1 may be further enclosed within another decorative or protective outer container 13, as shown in FIG. 1. With the optional decorative or protective outer container 13, the small multi-dose container 1 may be replaced after the individual chambers 2 are depleted while still retaining the outer container 13 for reuse.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A multi-dose container comprising:
multiple individual chambers, each with an inside dimension; and
an applicator with an elongated hollow handle with approximately the same outside dimension as the inside dimension of the individual chambers;
wherein said applicator is insertable into said individual chambers.

2. A multi-dose container as in claim 1, wherein a substance in disposed in said multiple individual chambers.

3. A multi-dose container as in claim 1, wherein said individual chambers are sealed with a seal.

4. A multi-dose container as in claim 3, wherein said individual chambers are sealed with an aluminum foil or a plastic covering.

5. A multi-dose container as in claim 1, wherein said individual chambers has a cross section in the shape of a circle, triangle, square, pentagon, or hexagon.

6. A multi-dose container as in claim 1, wherein said multiple individual chambers form a circular, triangular, square, pentagon, or hexagon shape.

7. A multi-dose container as in claim 3, wherein said seal has a weakened area corresponding to each individual chamber.

8. A multi-dose container as in claim 1, wherein a guide plate with corresponding openings to the individual chambers is disposed on top of the multiple individual chambers.

9. A multi-dose container as in claim 8, wherein said openings on said guide plate are provided with a chamfer to guide the applicator into said individual chamber.

10. A multi-dose container as in claim 1, wherein an applicator tip is affixed to an end of said applicator.

11. A multi-dose container as in claim 1, wherein a second container with multiple chambers corresponding to said multiple individual chambers are disposed under said multiple individual chambers.

12. A multi-dose container as in claim 11, wherein said multiple chambers in said second container are sealed with a seal.
